(19) United States
(12) Patent Application Publication
(10) Pub. No.: US 2006/0216573 A1
(43) Pub. Date: Sep. 28, 2006

(54) Power supply incorporating a chemical energy conversion device

(76) Inventor: Dennis M. Pfister, San Luis Obispo, CA (US)

Correspondence Address: Henry C. Query, Jr., 504 S. Pierce Avenue, Wheaton, IL, 60187, US

(21) Appl. No.: 11/388,585

(22) Filed: Mar. 24, 2006

Related U.S. Application Data
(60) Provisional application No. 60/665,113, filed on Mar. 25, 2005.

(51) Int. Cl. H01M 8/02; H01M 8/04

(52) U.S. Cl. 429/38; 429/22

(57) ABSTRACT

A device for generating an electric current comprises a housing, a reaction chamber which is positioned in the housing, and a chemical energy conversion device (“CECD”) which is positioned in the housing adjacent the reaction chamber. In operation, first and second reactants are communicated through respective conduits into the reaction chamber, where they react on the CECD and generate chemical energy which the CECD converts into an electric current. This electric current is then is transmitted to an external device over a pair of leads in order to power the external device.

This application is based on and claims the benefit of U.S. Provisional Patent Application No. 60/665,113, which was filed on Mar. 25, 2005.

### BACKGROUND OF THE INVENTION

This invention relates to a method and apparatus for converting chemical energy into electrical energy. More specifically, the invention relates to various devices which harness the electrical energy so produced for useful purposes.

A variety of known devices exist for converting the chemical energy of two or more chemical reactants into another form of energy, such as electrical energy. In these devices, which are referred to herein as chemical energy conversion devices (“CECD's”), the chemical reactants react on a catalyst and produce vibrationally excited reaction products. These reaction products in turn emit excitations, such as hot electrons or hot phonons, which are transmitted through the catalyst and into an energy converter, such as a quantum well or a semiconductor. Depending on the particular construction of the CECD, the energy converter then converts the excitations into a useful forms of energy, such as an electric current, an electric potential or electromagnetic radiation.

CECD's are commonly designed so that the distance between the surface of the catalyst and the energy converter is sufficiently small to prevent the excitations from reaching thermal equilibrium. As a result, a substantial portion of the chemical energy of the reactants is converted into a useful form of energy before this energy is converted into heat. Consequently, CECD's can achieve efficiencies of around 50 percent, which makes them ideal for powering a variety of devices.

Examples of various CECD's are described more fully in U.S. Pat. Nos. 6,114,620; 6,700,056; 6,678,305; and 6,649,823; and U.S. Patent Application Publication Nos. US 2002/0017827 A1; US 2002/0121088 A1; US 2003/0000570 A1; US 2003/0166307 A1; and US 2004/0182431 A1, which are hereby incorporated herein by reference.

### SUMMARY OF THE INVENTION

In accordance with the present invention, a device for converting chemical energy into electrical energy is provided which comprises a housing, a reaction chamber which is positioned in the housing, and a CECD which is positioned in the housing adjacent the reaction chamber. In operation, first and second reactants are communicated through respective first and second conduits into the reaction chamber, where they react on the CECD and generate chemical energy which the CECD converts into an electric current. This electric current is then transmitted to an external device over a pair of leads in order to power the external device.

In accordance with one embodiment of the invention, the device also includes an means for inducing the flow of the first reactant into the reaction chamber. This means may comprise, for example, an air mover which is positioned in the first conduit, or a venturi device which is positioned in the second conduit upstream of an intersection of the first and second conduits.

In accordance with another embodiment of the invention, the second reactant is stored in a container which is positioned in the housing. In addition, the device may include means for inducing the flow of the second reactant into the reaction chamber. This means may comprise, for example, means for elevating the pressure in the container above the pressure in the reaction chamber, such as a pump, a piston or an inflatable bladder.

In accordance with a further embodiment of the invention, the device also comprises a third conduit which extends between the reaction chamber and the environment and through which waste products generated by the chemical reaction are vented. Means may also be provided for cooling the waste products. Such cooling means may comprise a heat exchanger which is thermally coupled between the third conduit and at least one of the first and second conduits.

The device may also comprise means for rejecting waste heat generated by the chemical reaction from the reaction chamber. In one embodiment of the invention, the reaction chamber is comprised of metal and the heat rejecting means comprises the reaction chamber.

In accordance with yet another embodiment of the invention, the device comprises means for controlling the flow of the first and second reactants through their respective first and second conduits. This means may include, for example, a valve which is positioned in one of the first and second conduits.

Furthermore, the device may comprise a controller for controlling the operation of the flow control means to thereby regulate the chemical reaction to produce a desired electrical current. In addition, the device may include a sensor for sensing a condition which is related to the chemical reaction. This sensor may be connected to the controller so that the controller can control the operation of the flow control means in response to the condition sensed by the sensor.

The objects and advantages of the present invention will be made apparent from the following detailed description, with reference to the accompanying drawings. In the drawings, the same reference numbers are used to denote similar components in the various embodiments.

### BRIEF DESCRIPTION OF THE DRAWINGS

FIG. 1 is a schematic representation of an exemplary prior art CECD;

FIG. 2 is a schematic representation of one embodiment of a power supply of the present invention which incorporates a number of exemplary CECD's;

FIG. 3 is a schematic representation of a second embodiment of a power supply of the present invention which incorporates a number of exemplary CECD's;

FIG. 4 is a schematic representation of another embodiment of a power supply of the present invention which incorporates a number of exemplary CECD's;

FIG. 5 is a top plan of yet another embodiment of a power supply which incorporates a number of exemplary CECD's;

FIG. 5 is a schematic representation of a reactant supply system in accordance with the present invention which may be used with a chemical energy conversion device of any of the embodiments described herein;

FIG. 6 is a schematic representation of one embodiment of a battery replacement device of the present invention which incorporates a number of exemplary CECD's;

FIG. 7 is a schematic representation of one embodiment of a battery charger device which incorporates a number of exemplary CECD's; and

FIG. 8 is a schematic representation of the battery charger device taken along line A-A of FIG. 7.

### DETAILED DESCRIPTION OF THE PREFERRED EMBODIMENTS

The present invention comprises any of a variety of known devices for converting the chemical energy of two or more chemical reactants into another form of energy, such as electrical energy. In these devices, which are referred to herein as chemical energy conversion devices (“CECD's”), the chemical reactants react on a catalyst and produce vibrationally excited reaction products. These reaction products in turn emit excitations, such as hot electrons or hot phonons, which are transmitted through the catalyst and into an energy converter, such as a quantum well or a semiconductor. Depending on the particular construction of the CECD, the energy converter then converts the excitations into a useful forms of energy, such as an electric current, an electric potential or electromagnetic radiation.

CECD's are commonly designed so that the distance between the surface of the catalyst and the energy converter is sufficiently small to prevent the excitations from reaching thermal equilibrium. In this manner, a substantial portion of the chemical energy of the reactants is converted into a useful form of energy before this energy is converted into heat. Consequently, CECD's can achieve efficiencies of around 50 percent, which makes them ideal for powering a variety of devices.

Examples of various CECD's are described more fully in U.S. Pat. Nos. 6,114,620; 6,700,056; 6,678,305; and 6,649,823; and U.S. Patent Application Publication Nos. US 2002/0017827 A1; US 2002/0121088 A1; US 2003/0000570 A1; US 2003/0166307 A1; and US 2004/0182431 A1, which are hereby incorporated herein by reference.

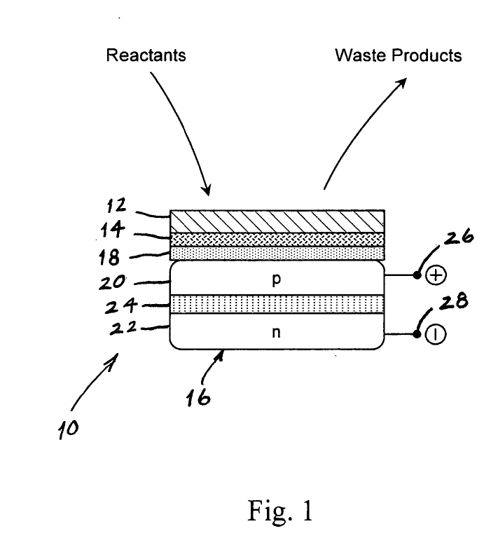

A schematic representation of an exemplary CECD which is particularly useful for producing an electric potential or electric current is shown in FIG. 1. The CECD of this embodiment, which is indicated generally by reference number 10, is shown to comprise a catalyst layer 12 which is mounted on a substrate 14 that in turn is physically connected to an energy converter 16 by an interface layer 18. In the illustrated embodiment of the CECD 10, the energy converter 16 comprises a p-n junction diode which includes a p-type semiconductor portion 20, an n-type semiconductor portion 22, a p-n junction 24 which is disposed between the p-type and n-type semiconductor portions, a positive electrode 26 which is connected to the p-type semiconductor portion, and a negative electrode 28 which is connected to the n-type semiconductor portion.

In operation, a fuel reactant and an oxidizer reactant react on the catalyst 12 and produce waste products which are exhausted by suitable means. The fuel reactant can comprise, for example, a known reducing material or electron donor, such as hydrogen, hydrocarbons, complex hydrocarbons, partially oxygenated hydrocarbons, carbohydrates, diesel fuel, kerosene, volatized products of organic matter, products of a fuel reformer such as hydrogen and carbon monoxide, combustible gases such as ammonia, and alcohols such as methanol, ethanol and propanol. In addition, the oxidizer reactant can comprise, for example, a known electron acceptor, such as oxygen, air, hydrogen peroxide and halogens. Also, the catalyst 12 can comprise any suitable metal, semiconductor or insulator which is capable of catalyzing a chemical reaction, such as aluminum, platinum, palladium, iridium, rhodium, ruthenium, vanadia, titania and alumina.

The reaction of the fuel and oxidizer reactants on the catalyst 12 produces hot electrons which are transported through the substrate 14 and the transition layer 18 and into the p-type semiconductor portion 20 of the diode 16, where they are converted into minority carriers. The minority carriers are then drawn into the p-n junction 24 under the influence of diffusion forces and the internal electric field of the junction. This internal electric field causes the minority carriers to become majority carriers in the n-type semiconductor portion 22 of the diode 16, which in turn causes the diode to become forward biased. This forward bias generates a potential which can be output as a current between the positive and negative electrodes 26, 28.

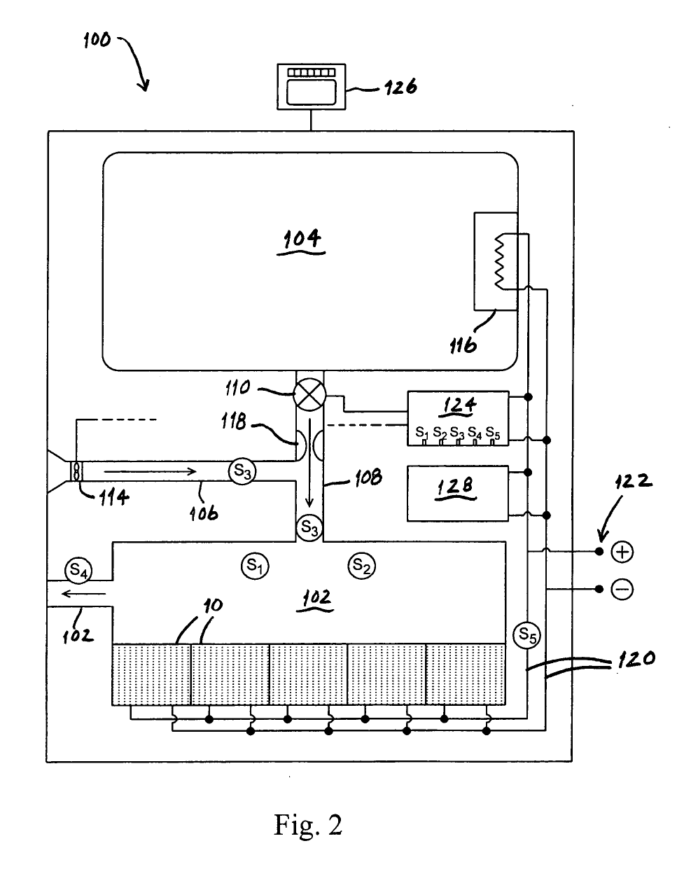

Referring to FIG. 2, one embodiment of the present invention comprises a number of CECD's 10 as the energy source for a power supply. The power supply of this embodiment, which is indicated generally by reference number 100, includes a reaction chamber 102 and means for communicating a number of chemical reactants into the reaction chamber. The CECD's 10 are positioned in or adjacent the reaction chamber 102 so that the chemical reactants will react on the CECD's and thereby cause the CECD's to generate an electric potential or an electric current. As with prior art power supplies, this electric potential or electric current can then be used to power various external devices.

In an exemplary embodiment of the power supply 100, the CECD's 10 are designed to operate with two chemical reactants, R₁ and R₂. In the embodiment of the invention which is shown in FIG. 2, for example, the first reactant R₁ may comprise airborne oxygen and the second reactant R₂ may comprise a hydrogen-based fuel, such as butane. Accordingly, the first reactant R₁ may be obtained from the ambient environment and the second reactant R₂ may be stored in a suitable container 104 which is housed in or adjacent the power supply 100.

The power supply 100 ideally includes at least first and second conduits 106, 108 through which the respective first and second reactants R1, R2 may be communicated to the reaction chamber 102. Although not required, the first conduit 106 may be connected to the second conduit 108 upstream of the reaction chamber 102 to allow the first and second reactants R₁, R₂ to mix together somewhat prior to their entering the reaction chamber. Alternatively, the first and second conduits 106, 108 may each comprise a separate passageway which is connected directly to the reaction chamber 102. Also, one or both of the conduits 106, 108 may comprise a suitable valve 110 for controlling the flow of the respective reactants R1, R2 into the reaction chamber 102. In addition, the waste products generated by the reaction of the first and second reactants R1, R2 are ideally vented through an exhaust conduit 112 which is connected to the reaction chamber 102.

The power supply 100 preferably comprises one or more means for inducing the flow of the first and second reactants R₁, R₂ into the reaction chamber 102. For example, the power supply 100 may include an air mover 114, such as a fan or a compressor, which is mounted in or adjacent the first conduit 106 and which draws the first reactant R₁ through the first conduit and into the reaction chamber 102. Also, the second reactant R₂ may be stored under pressure in the container 104 so that, when the valve 110 is opened, the second reactant will naturally expand through the second conduit 108 and into the reaction chamber 102. Alternatively, the power supply 100 may comprise one or more pressurizing devices 116 for elevating the pressure of the second reactant R₂ above that of the reaction chamber 102. For example, a suitable pressurizing device 116 may comprise a heating element which is mounted in or on the container 104 and which when energized will increase the temperature and, thus, the pressure of the second reactant R₂. Additional examples of some exemplary pressurizing devices 116 will be described below in connection with other embodiments of the present invention.

In addition or as an alternative to the flow inducing means described above, one of the conduits 106, 108 could be provided with a venturi device or the like, such as a conventional siphon injector, to draw the reactant through the other conduit and into the reaction chamber 102. In the embodiment of the invention which is shown in FIG. 2, for example, the second conduit 108 comprises a venturi device 118 which is positioned just upstream of the intersection of the first and second conduits 106, 108. Thus, as the second reactant R₂ flows through the venturi device 118, it will create low pressure condition downstream of the venturi device which will draw the first reactant R₁ through the first conduit 106 and into the second conduit 108. Alternatively, the first and second conduits 106, 108 may be constructed and arranged such that the flow of the first reactant R₁ through a venturi device in the first conduit will create a low pressure condition which will draw the second reactant R₂ through the second conduit and into the first conduit. Additional examples of some exemplary flow inducing means will be described below in connection with other embodiments of the present invention.

In operation of the power supply 100, the first and second reactants R₁, R₂ are communicated to the reaction chamber 102, where they will chemically react on the CECD's 10. The CECD's 10 will convert the chemical energy of this reaction into electrical energy, which when the power supply 100 is connected to an external device will be output by the CECD's as an electric current. In an exemplary embodiment of the power supply 100, this current is transmitted over a pair of leads 120 to a terminal 122. From the terminal 122, the current can be stored, converted into other forms of energy or transmitted for use elsewhere.

The maximum power which the power supply 100 is capable of generating is related to the quantities of the first and second reactants R₁, R₂ which can chemically react in a given period of time, which in turn is related to the total reaction surface area of the catalyst portion of the CECD's 10 on which the first and second reactants may react. Thus, the maximum power which the power supply 100 can generate may be pre-selected by controlling the supply of the first and second reactants R₁, R₂ and/or the surface area of the CECD's 10 on which the first and second reactants may react.

For example, if a particular application requires that the power supply 100 be capable of delivering 50 W of power, then the rate at which each of the first and second reactants R₁, R₂ must be supplied to the CECD's 10 can be determined as follows. As discussed above, the maximum efficiency of the CECD's 10 in converting the chemical energy of the first and second reactants R₁, R₂ into electrical energy is currently around fifty percent. Thus, in order for the CECD's 10 to produce 50 W of power, the reaction between the first and second reactants R₁, R₂ must yield a minimum of 100 W of power, or 100 J of energy per second. The amounts of each of the first and second reactants R₁, R₂, which can generate 100 J of energy can be determined from standard handbooks of chemical reactions. Furthermore, in order to generate 100 W of power, these amounts of the first and second reactants R₁, R₂ must be supplied to the CECD's 10 each second. Assuming that the CECD's 10 are sufficiently large to enable the reaction of these amounts of the first and second reactants R₁, R₂ each second, and assuming that the reaction is not affected by any other factors, each of the first and second reactants must be supplied to the CECD's at these rates in order for the power supply 100 to be able to generate 100 W of power.

Furthermore, once the rates at which the first and second reactants R₁, R₂ must be supplied to CECD's 10 is known, the minimum size of the CECD's which is sufficient to support the required reaction rate can be determined. For example, for a given catalyst having a predetermined reaction surface area, the amounts of the first and second reactants R₁, R₂ which can react on the catalyst each second can be determined empirically. Moreover, the reaction rate for each of a number of different reaction surface areas can also be determined empirically, and this relationship can be used to determine the minimum reaction surface area which will support the reaction rate which is required to enable the power supply 100 to generate 50 W of power. Furthermore, once the minimum reaction surface area is known, the size of the CECD's 10 which will provide this reaction surface area can be determined from the known relationship between the physical dimensions of the catalyst and its corresponding CECD.

Thus, by increasing or decreasing the rate at which the first and second reactants R₁, R2 are supplied to the reaction chamber 102, or by increasing or decreasing the surface area of the CECD's 10 on which the first and second reactants may react, the maximum power which the power supply 100 is capable of producing can be varied accordingly. Consequently, the power supply 100 can be designed to have a capacity which is appropriate for a variety of devices, from small electrical devices such as cell phones and portable computers, to large electrical devices such as household appliances and desktop computing systems.

Referring still to FIG. 2, the power supply 100 may also include a suitable controller 124 for controlling the operation of certain components of the power supply. The controller 124 may comprise a programmable controller which includes an associated memory for storing the parameters under which these components may be controlled. For example, the controller 124 may control the operation of the air mover 114 to selectively communicate the first reactant R₁, into the reaction chamber 102. In addition, the controller 124 may control the operation of the valve 110, which in this case may be a solenoid-activated ball valve or the like, to selectively communicate the second reactant R₂ into the reaction chamber 102.

The controller 124 ideally controls the operation of the components of the power supply 100 in a manner which will enable the power supply to generate a desired power. As discussed above, the energy which the CECD's 10 can produce depends in part on the rates at which the first and second reactants R₁, R₂ are supplied to the reaction chamber 102. Accordingly, the energy which the CECD's 10 actually produce, and thus the power which the power supply 100 is capable of generating, can be varied by controlling these supply rates.

In one embodiment of the invention, the appropriate supply rates for the first and second reactants R₁, R₂ may be determined empirically for each of a number of desired power levels. These supply rates can then be stored in, for example, a look-up table in the controller 124. Thus, when a desired power level is selected, such as through a conventional input device 126 which is connected to the controller 124, the controller will operate the valve 110, the air mover 114 and/or any other applicable component of the power supply 100 in order to achieve and maintain the corresponding supply rates for the first and second reactants R₁, R₂.

In accordance with another embodiment of the present invention, the controller 124 may be programmed to operate in a feedback control loop. In this embodiment, the power supply 100 ideally comprises a number of sensors for measuring certain characteristics of the chemical reaction and/or the CECD's 10. The signals representing these measured characteristics are transmitted to the controller 124, which employs one or more process control programs to control the operation of certain components of the power supply 100 to thereby ensure that the power supply maintains a desired power level while operating in an efficient manner. In this regard, the person of ordinary skill in the art can readily derive the specifics of such process control programs from the following descriptions of the sensors S₁ through S₄.

In an exemplary embodiment of the invention, the power supply 100 may comprise a temperature sensor S₁, such as a conventional thermistor, for sensing the temperature in the reaction chamber 102. As discussed above, the CECD's 10 operate most efficiently by converting the chemical energy of the first and second reactants R₁, R₂ into electrical energy before the chemical energy can be converted into heat. If at any given time the quantities of the first and second reactants R₁, R₂ in the reaction chamber 102 are too high, however, the CECD's 10 will not be able to convert all of the chemical energy directly into electrical energy, and some of the chemical energy will instead be converted into heat. This will result in an increase in the temperature in the reaction chamber 102. Thus, if the temperature measured by the temperature sensor S₁ is higher than a predetermined temperature, which may be determined empirically, then the rates at which the first and second reactants R₁, R₂ are being supplied to the reaction chamber 102 may be too high. In this case, the controller 124 may be programmed to operate the appropriate components of the power supply 100, such as the valve 110 and/or the air mover 114, to adjust the supply rates of the first and second reactants R₁, R₂ in order to maintain the temperature in the reaction chamber 102 below the predetermined temperature.

In addition or as an alternative to the temperature sensor S₁, the power supply 100 may comprise an appropriate number of suitable chemical sensors S₂ for detecting the amounts of the first and second reactants R₁, R₂ in the reaction chamber 102. The power supply 100 will operate most efficiently when the first and second reactants R₁, R₂ are present in the reaction chamber 102 in certain proportions, which may be determined empirically. Thus, the controller 124 may be programmed to determine the amounts of the first and second reactants R₁, R₂ in the reaction chamber 102 based on the signal received from the sensor S₂, calculate the proportions of each of these reactants in the reaction chamber, and then adjust the components of the power supply 100, such as the valve 110 and/or the air mover 114, to maintain the proportions of the first and second reactants at or near the desired levels.

In addition or as an alternative to the temperature sensor S₁ and the chemical sensor S₂, the power supply 100 may comprise a number of conventional flow sensors S₃ for measuring the flow rate of each of the first and second reactants R₁, R₂ through their corresponding conduits 106, 108. As discussed above, the amount of power which the power supply 100 is capable of generating depends in part on the rate at which the first and second reactants R₁, R₂ are communicated to the reaction chamber 102. Thus, the controller 124 may be programmed to monitor the flow rates of the first and second reactants R₁, R₂ through their corresponding conduits 106, 108, and then adjust the components of the power supply 100, such as the valve 110 and/or the air mover 114, to maintain the flow rates near their desired levels.

In addition or as an alternative to the temperature sensor S₁, the chemical sensor S₂ and the flow sensor S₃, the power supply 100 may comprise an appropriate number of suitable chemical sensors S₄ for detecting the identities and respective amounts of the chemicals in the exhaust stream exiting the reaction chamber 102. These chemicals may provide an indication that too much or too little of one or both of the first and second reactants R₁, R₂ is being supplied to the reaction chamber 102. For example, an inordinate amount of the first reactant R₁ in the exhaust stream may be an indication that more of this reactant than is capable of reacting with the second reactant R₂ is being supplied to the reaction chamber 102. Also, a deficiency in the amounts of the products of the reaction between the first and second reactants R₁, R₂ may be an indication that too little of both of these reactants is being supplied to the reaction chamber 102. The identities and appropriate amounts of the chemicals which should be present in the exhaust stream when the power supply 100 is operating efficiently may be determined empirically. Thus, the controller 124 may be programmed to determine the identities and respective amounts of the chemicals in the exhaust stream based on the signal received from the sensor S₄, and then adjust the components of the power supply 100, such as the valve 110 and/or the air mover 114, to maintain the amounts of these chemicals at or near their appropriate levels.

In addition or as an alternative to the temperature sensor S₁, the chemical sensor S₂, the flow sensor S₃ and the chemical sensor S₄, the power supply 100 may comprise a conventional current sensor S₅ for measuring the electric current which is generated by the CECD's 10. For a given power supply 100, the current produced by the CECD's 10 is proportional to the supply of the first and second reactants R₁, R₂. Moreover, the relationship between the supply of the first and second reactants R₁, R₂ and the current produced by the CECD's 10 can be determined empirically and stored as an algorithm in the controller 124. Thus, if the power supply 100 is set to produce a desired current, the controller 124 may be programmed to compare this desired current with the actual current produced by the CECD's 10, as measured by the current sensor S₅, and adjust the components of the power supply, such as the valve 110 and/or the air mover 114, to correct for any deviation between these values.

As shown in FIG. 2, the energy which is generated by the CECD's 10 may be used to power the various components of the power supply 100, such as the valve 110, the air mover 114, the pressurizing device 116 and the controller 124. However, before the first and second reactants R₁, R₂ undergo their chemical reaction, the CECD's 10 are incapable of generating the energy required to power these components.

Thus, the power supply 100 ideally comprises an energy storage device 128 for powering certain components of the power supply prior to the initiation of the chemical reaction between the first and second reactants R₁, R₂. The energy storage 128 device may comprise, for example, a battery which is sized to provide a sufficient amount of energy to the desired components of the power supply 100 until the CECD's 10 can do so. In addition, the energy storage device 128 may be rechargeable, in which event the power supply 100 may be designed to enable the CECD's 10 to charge the energy storage device when it is not in use. Moreover, the energy storage device 128 may be rechargeable in accordance with a suitable recharging algorithm which is stored in the controller 124.

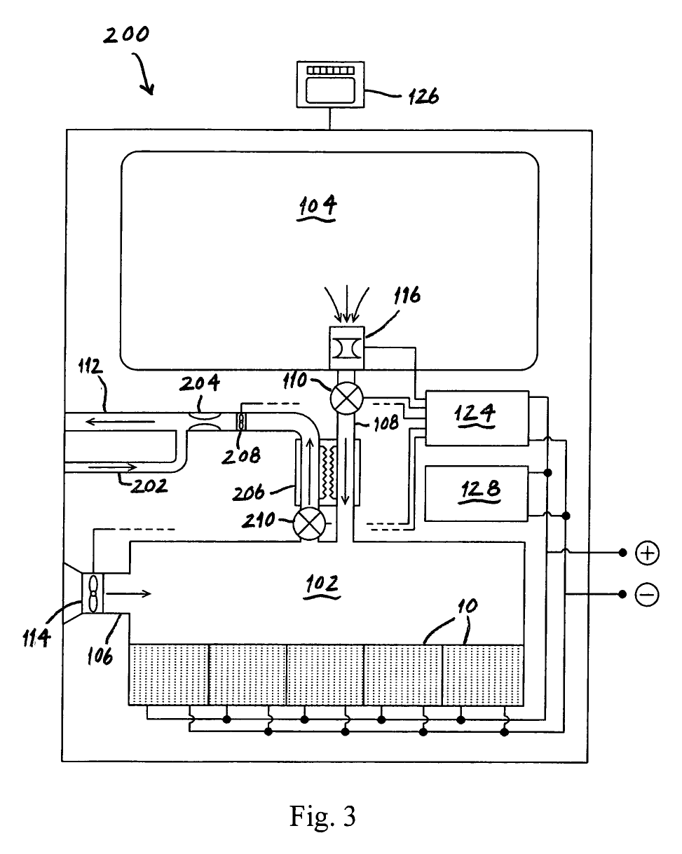

Referring now to FIG. 3, another exemplary power supply is shown which is similar in many respects to the power supply 100 but which includes several additional features that have not been previously described. Like the power supply 100, the power supply of FIG. 3, which is referred to generally by reference number 200, comprises a number of CECD's 10 which are positioned in or adjacent a reaction chamber 102, a first conduit 106 for communicating a first reactant R₁, such as airborne oxygen, to the reaction chamber 102, a second conduit 108 for communicating a second reactant R₂ from its corresponding container 104 to the reaction chamber, and an exhaust conduit 112 through which the waste products of the reaction between the first and second reactants may be exhausted.

In this embodiment of the invention, the pressurizing device 116 may comprise a pump which includes an inlet in communication with the container 104 and an outlet in communication with the second conduit 108. When activated, such as by the controller 124, the pump 116 will force the second reactant R₂ through the second conduit 108 and into the reaction chamber 102. The pump 116 is particularly useful when the pressure of the second reactant R₂ in the container 104 is not significantly greater than the pressure of the reaction chamber 102. Also, depending on the type of pump 116 which is employed in the power supply 200, the valve 110 may not be necessary and accordingly may be omitted.

The power supply 200 also includes means for cooling the exhaust stream exiting the reaction chamber 102. Although the energy of the chemical reaction between the reactants R₁, R₂ is ideally converted directly to electrical energy, the inherent inefficiencies in the CECD's 10 will result in some of the chemical energy being converted to waste heat. A portion of this waste heat will be exhausted through the exhaust conduit 112 with the waste products produced by the reaction of the first and second reactants R₁, R₂. Under certain circumstances, the amount of heat in the exhaust stream can be significant, and this heat may therefore be problematic when the power supply 200 is used to power certain devices, such as portable computers or cell phones.

In one embodiment of the invention, the cooling means may comprise a cooling conduit 202 for introducing ambient air into the exhaust stream. As shown in FIG. 3, the cooling conduit 202 is connected between the ambient environment and a portion of the exhaust conduit 112 located upstream of the point at which the exhaust conduit exits the power supply 200. The ambient air may be drawn through the cooling conduit 202 by a venturi device 204 which is positioned in the exhaust conduit 112 just upstream of its intersection with the cooling conduit.

In addition or as an alternative to the cooling conduit 202, the cooling means may comprise a heat exchanger 206 for extracting heat from the exhaust stream. The heat exchanger is ideally positioned in heat exchange relation with respect to both the exhaust conduit 112 and a heat sink, such as an array of cooling fins or a heat-conductive portion of the housing of the power supply 200. In the embodiment of the invention which is shown in FIG. 3, for example, the heat sink comprises the second conduit 108. In this embodiment, the second reactant R₂ is ideally stored in the container 104 at a pressure which is greater than the pressure of the reaction chamber 102. Accordingly, as the second reactant R₂ is released into the second conduit 108, it will expand and absorb heat from its environment, which in this case is the heat exchanger 206. Thus, the heat exchanger 206 will effectively transfer the heat from the exhaust stream into the second reactant R₂ as the second reactant is communicated into the reaction chamber 102. Additional examples of some exemplary cooling means, which may also be referred to herein as heat rejecting means, will be described below in connection with other embodiments of the present invention.

The power supply 200 may also include an air mover 208 for propelling the exhaust stream through the exhaust conduit 112. The air mover 208 may be beneficial in circumstances where the pressure in the reaction chamber is not significantly greater than that of the ambient environment. The air mover 208 will also supplement the ability of the venturi device 204 to draw ambient air through the cooling conduit 202.

The power supply 200 may further include a valve 210 for selectively opening and closing the exhaust conduit 112. In certain circumstances, the reaction between the first and second reactants R₁, R₂ will transpire over a period of time. Therefore, the first and second reactants R₁, R₂ must be contained within the reaction chamber 102 during this reaction time. This can be accomplished by closing the valve 210 until the reaction between the first and second reactants R₁, R₂ is substantially completed. In this regard, the valve 210 may be operated by the controller 124 to maintain the first and second reactants within the reaction chamber 102 for a desired reaction time, which may be determined empirically.

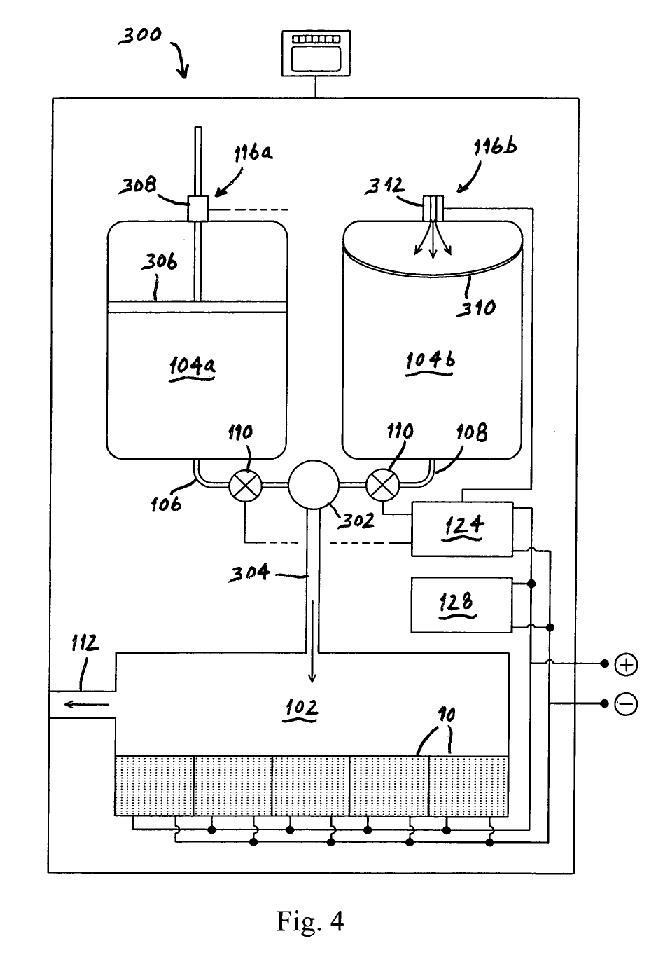

Referring to FIG. 4, another exemplary power supply is shown which is similar in many respects to the power supplies 100 and 200 but which includes several additional features that have not been previously described. The power supply of this embodiment, generally 300, comprises a number of CECD's 10 which are positioned in or adjacent a reaction chamber 102, a fist container 104a for storing a first reactant R₁, such as pure oxygen, and a second container 104b for storing a second reactant R₂, such as butane. The first and second reactants R₁, R₂ are communicated via respective first and second conduits 106, 108 to a mixing device 302, where they are mixed together prior to being communicated, either directly or via a third conduit 304, to the reaction chamber 102. The mixing device 302 may comprise any conventional apparatus which is capable of thoroughly mixing the first and second reactants R₁, R₂. Examples of certain mixing devices which are suitable for use with the present invention are disclosed in U.S. Pat. Nos. 6,303,501 and 6,779,786, which are hereby incorporated herein by reference.

The power supply 300 may also comprise a pressurizing device 116 for one or each of the containers 104a, 104b. For example, the container 104a may comprise a piston-type pressurizing device 116a which includes a piston 306 that is advanced by a suitable actuator 308 which in turn may be operated by the controller 124. In operation, the piston 306 may be actuated to increase the pressure of the first reactant R₁ when the valve 110 is closed, or to force the first reactant through the first conduit 106 when the valve 110 is open. Also, the container 104b may comprise a diaphragm-type pressurizing device 116b which includes a flexible diaphragm or bladder 310 that is displaced or inflated by a suitable inflation device 312 which may be operated by the controller 124. In operation, the diaphragm or bladder 310 may be inflated to increase the pressure of the second reactant R₂ when the valve 110 is closed, or to force the second reactant through the second conduit 108 when the valve 110 is open. Alternatively, the pressurizing device 116b may simply comprise a device for injecting an inert gas under pressure into the container 104b to thereby increase the pressure of the second reactant R₂ when the valve 110 is closed, or to force the second reactant through the second conduit 108 when the valve 110 is open.

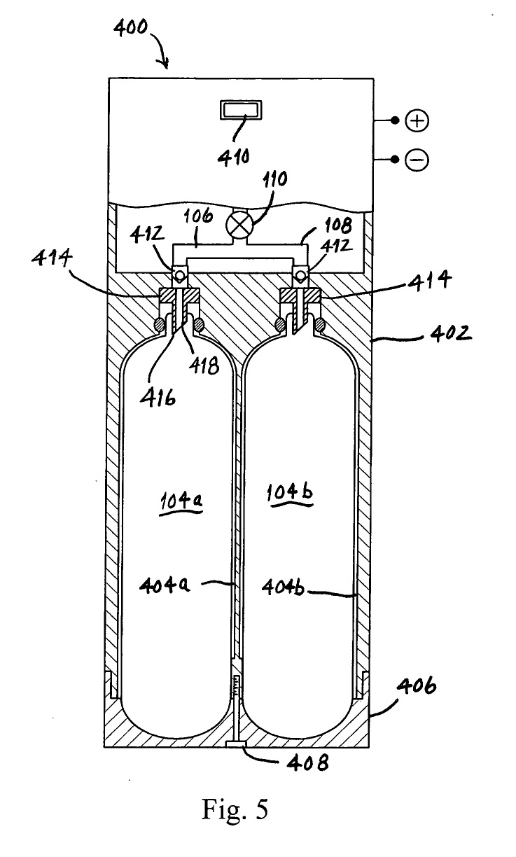

Referring now to FIG. 5, another embodiment of the present invention is shown which may be used to provide portable power to a variety of electrical devices. The power supply of this embodiment, which is indicated generally by reference number 400, is similar in many respects to the power supplies previously described in that is comprises one or more CECD's which are mounted in or adjacent a reaction chamber (not shown). The power supply 400 also comprises a housing 402 and first and second containers 104a, 104b which are removably mounted in corresponding receptacles 404a, 404b that are formed in the housing. Accordingly, when one of the containers 104a, 104b becomes depleted, it may be removed and replaced with a new container. To facilitate this operation, the housing 402 may comprise a cover 406 which is secured to the housing by, for example, a screw 408, and which may be removed to provide access to the containers 104a, 104b.

The first and second containers 104a, 104b are connected to the reaction chamber via respective first and second conduits 106, 108. In addition, a valve 110 may be interposed between the containers 104a, 104b and the reaction chamber in order to control the flow of the first and second reactants R₁, R₂ into the reaction chamber. As in the previous embodiments, the valve 110 may be operated by a suitable controller to supply the first and second R₁, R₂ reactants to the reaction chamber in accordance with certain pre-programmed parameters. Alternatively, the valve 110 may comprise a solenoid-activated valve which may be operated by a switch 410, or a mechanically-actuated valve which may be operated by a suitable slide or handle (not shown).

The power supply 400 may also comprise one or more pressurizing means for one or each of the containers 104a, 104b. For example, each of the first and second reactants R₁, R₂ may be stored under pressure in its corresponding container 104a, 104b. Thus, when the valve 110 is opened, the first and second reactants R1, R2 will naturally expand into the reaction chamber. In this case, the power supply 400 may also include a pair of check valves 412, each of which is positioned between a corresponding container 104a, 104b and the reaction chamber to ensure that one of the reactants does not expand into the container for the other reactant.

In an exemplary embodiment of the power supply 400, the containers 104a, 104b are pre-sealed cartridges which are automatically opened as they are installed in the housing 402. In this embodiment, the power supply 400 ideally comprises a pair of cartridge piercing devices 414, each of which is positioned in the housing 402 opposite a frangible membrane that covers an opening in a corresponding cartridge 104a, 104b. Each cartridge piercing device 414 includes a spear portion 416 which pierces the frangible membrane when the container 104a, 104b is inserted into its corresponding receptacle 404a, 404b, and a fluid port 418 which extends between the cartridge opening and a corresponding conduit 106, 108. Thus, as the cartridge 104a, 104b is inserted into its corresponding receptacle 404a, 404b, the cartridge piercing device 414 will pierce the cartridge and place its contents in communication with its corresponding conduit 106, 108.

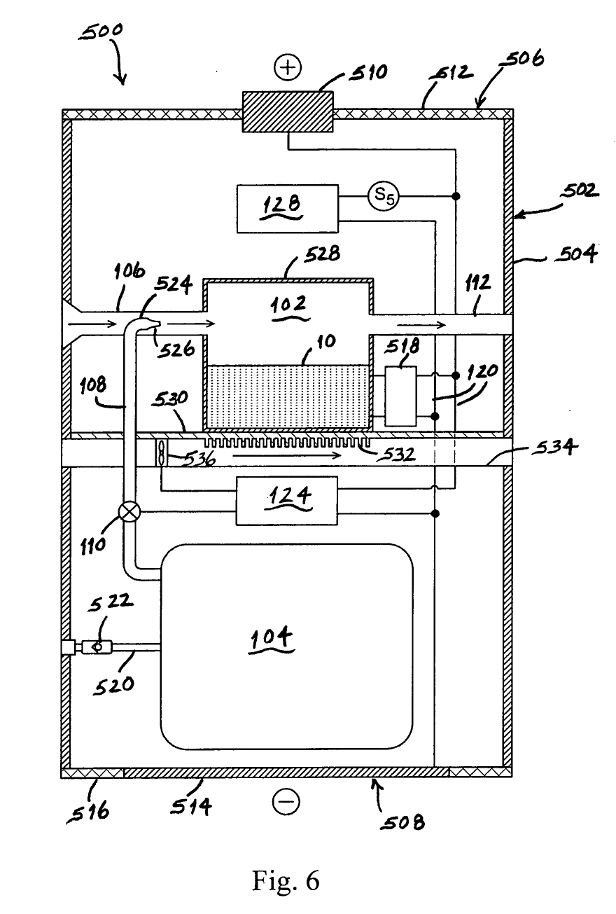

Another embodiment of the present invention is illustrated in FIG. 6. The power supply of this embodiment, generally 500, is specifically adapted for use as a substitute for a conventional battery. As with the power supplies described above, the power supply 500 includes one or more CECD's 10 which are positioned in or adjacent a reaction chamber 102, a first conduit 106 for communicating a first reactant R₁, such as airborne oxygen, to the reaction chamber, a second conduit 108 for communicating a second reactant R₂ from its associated container 104 to the reaction chamber, and an exhaust conduit 112 for exhausting the waste products of the reaction between the first and second reactants from the reaction chamber.

In this embodiment of the invention, the components of the power supply 500 are positioned in a housing 502 which comprises an exterior configuration similar to a battery which the power supply is intended to replace. For example, the housing 502 may comprise a generally cylindrical wall portion 504, a circular top portion 506 and a circular bottom portion 508. In addition, the top portion 506 may comprise an electrically conducting central section 510 and an insulating peripheral section 512. Similarly, the bottom portion 508 may comprise an electrically conducting central section 514 and an insulating peripheral section 516. The central sections 510, 514 of the top and bottom portions 506, 508 are connected to the leads 120 of the power supply 500 and accordingly serve as the respective positive and negative contacts of the power supply. In operation, the current which is generated by the CECD's 10 is transmitted over the leads 120 to the central sections 510, 514 and from there to the electrical device in which the power supply 500 is installed.

The power supply 500 may also comprise means for initiating the supply of current to the contacts 510, 514. For example, the power supply 500 may comprise an energy storage device 128 for producing an initial voltage across the contacts 510, 514, a current sensor S₅ for detecting the initial load on the energy storage device, and preferably also a controller 124 for actuating the valve 110 in the second conduit 108. In operation, when an external device to which the power supply 500 is connected applies a load across the contacts 510, 514, a current will begin to flow from the energy storage device 128, and this current will be detected by the current sensor S₅. In response to a signal from the current sensor S₅, the controller 124 will open the valve 110 and thereby initiate the flow of the second reactant R₂ into the reaction chamber 102, which will in turn induce the flow of the first reactant R₁into the reaction chamber in a manner which will be described below. When the first and second reactants R1, R2 react in the reaction chamber 102, the CECD's 10 will generate a current that will result in a voltage being produced across the contacts 510, 514. In this regard, the power supply 500 may include a voltage regulator 518 to ensure that the voltage produced by the CECD's corresponds to a desired voltage, such as that which is normally required to operate the external device.

It should be understood that the power supply 500 need not include a controller 500. Instead, the activation of the valve 110 could be initiated by the current sensor S₅ or by a suitable switching device which is responsive to the current sensor.

In an alternative embodiment of the invention, the voltage produced by the power supply 500 is provided solely by the energy storage device 128. In this embodiment, the CECD's 10 operate to charge the energy storage device 128 to maintain its energy level at or near a desired level. The power supply 500 may therefore include a suitable sensor for detecting the energy level of the energy storage device 128, and an appropriate switching device for initiating the flow of the first and second reactants R₁, R₂ into the reaction chamber when the energy storage device requires recharging.

The power supply 500 may also include means for refilling the container 104 with the second reactant R₂. The refilling means may comprise, for example, an inlet port 520 which is engageable by a refill tank containing the second reactant R₂, and a suitable valve 522 for selectively opening the inlet port. The valve 522 may comprise a poppet-type check valve which is normally closed but which can be forced open by a corresponding portion of the refill tank. The refilling means thus allows the power supply 500 to be “recharged” quickly and conveniently after the container 104 has been depleted of the second reactant R₂.

In this embodiment of the invention, the means for inducing the flow of the first reactant R₁ into the reaction chamber 102 comprises the second conduit 108. More particularly, the second conduit 108 comprises an exit portion 524 which extends partially into and ideally parallel to the first conduit 106. Similar to the venturi device 118 described above, when the second reactant R₂ exits the exit portion 524, a low pressure area will be created in the first conduit 106 downstream of the exit portion which will draw the first reactant R₁ through the first conduit 106 and into the reaction chamber 102. The velocity at which the second reactant R2 exits the exit portion 524, and thus the magnitude of the low pressure area which is created downstream of the exit portion, can be increased by providing the end of the exit portion with a suitably sized nozzle 526.

As mentioned above, due to the inherent inefficiencies of the CECD's 10, some of the chemical energy of the first and second reactants R1, R2 will be converted to waste heat, and a portion of this heat will be transmitted to both the reaction chamber 102 and the CECD's 10. Moreover, this waste heat will tend to lessen the efficiency of the CECD's 10. Therefore, the power supply 500 may include any of a variety of means for rejecting the waste heat from the reaction chamber 102 and/or the CECD's 10. In accordance with the present invention, these heat rejecting means may comprise conductive means, such as heat sinks, cooling fins or heat pipes; convective means, such as cooling ducts, fans or blowers; or radiative means; or a combination of one or more of these means.

Referring to FIG. 6, for example, one exemplary heat rejecting means may simply be a heat-conducting enclosure 528 for the reaction chamber 102. In operation, the enclosure 528 absorbs waste heat from the reaction chamber and the CECD's 10 and dissipates this heat into its environment either convectively or, depending on the amount of waste heat and the material of the enclosure, radiatively. If required, the enclosure 528 may include conventional means to electrically insulate it from the CECD's 10.

In addition or as an alternative to the enclosure 528, the heat rejecting means may comprise one or more heat sinks for the enclosure and/or the CECD's 10. For example, the heat rejecting means may comprise a heat dispersing plate 530 which is constructed of a heat-conducting material and is positioned in heat exchange relation with respect to the enclosure 528 and/or the CECD's 10. In addition, the heat dispersing plate 530 may comprise a number of cooling fins 532 which are positioned in heat exchange relation with respect to the enclosure 528 and/or the CECD's 10. In operation, waste heat from the reaction chamber 102 and/or the CECD's 10 will be conducted through the heat dispersing plate 530 and dissipated into the environment, either directly or via the cooling fins 532.

In another embodiment of the invention, the wall portion 504 of the housing 502 is constructed of a heat-conducting material, and the heat dispersing plate 530 is connected to the wall portion. Accordingly, waste heat from the reaction chamber 102 and/or the CECD's 10 will be conducted through the heat dispersing plate 530 to the wall portion 504 and then dissipated into the external environment of the power supply 500.

In a further embodiment of the invention, the heat rejecting means may comprise a cooling duct 534 which extends between the external environment of the power supply 500 and the enclosure 528 and/or the CECD's 10. For example, the cooling duct 534 may be positioned adjacent the heat dispersing plate 530 and/or the cooling fins 532. In this manner, heat from heat dispersing plate 530 and/or the cooling fins 532 will be dissipated convectively by the air flowing through the cooling duct 534. This process may be enhanced by providing a cooling fan 536 in the cooling duct 534. Moreover, the fan 536 may be operated by the controller 124, which may be programmed to activate the fan when the temperature of the CECD's 10, as measured by a conventional temperature sensor (not shown) reaches a predetermined level.

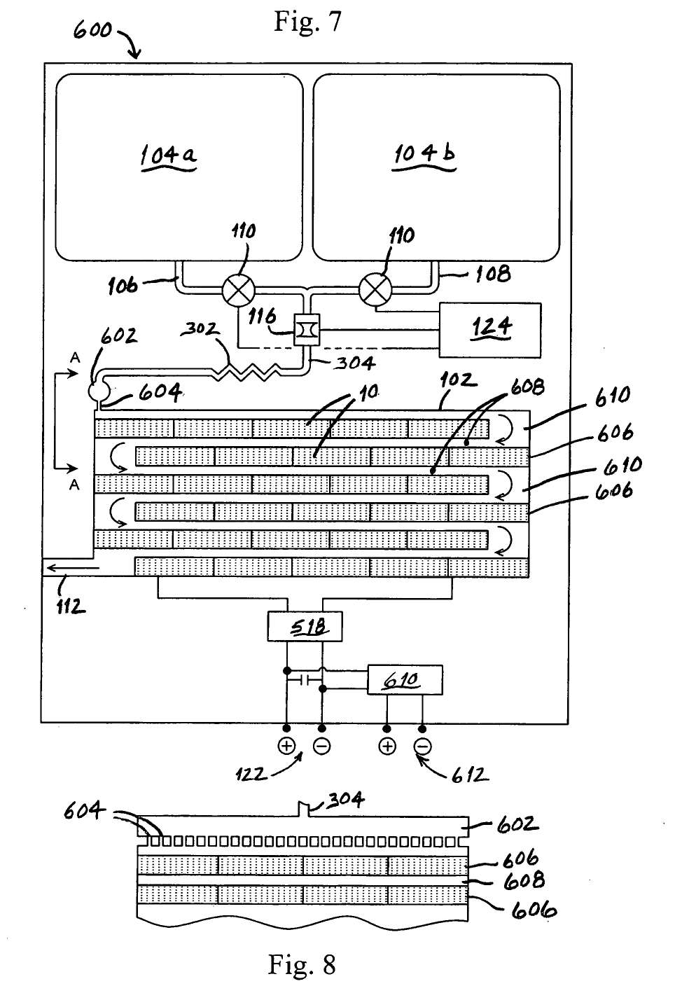

Referring to FIGS. 7 and 8, an embodiment of a power supply is shown which is specifically adapted for use as a batter charger and/or a generator. The power supply of this embodiment, which is indicated generally by reference number 600, includes one or more CECD's 10 which are positioned in or adjacent a reaction chamber 102, a first conduit 106 for communicating a first reactant R₁ from its corresponding container 104a to the reaction chamber, a second conduit 108 for communicating a second reactant R₂ from its corresponding container 104b to the reaction chamber, and an exhaust conduit 112 for exhausting the waste products of the reaction of the first and second reactants from the reaction chamber.

The power supply 600 may also include a pressurizing device 116, such as a pump, for propelling the first and second reactants R₁, R₂ through the first and second conduits 106, 108 and into a third conduit 304 which is connected to the reaction chamber 102. In addition, the third conduit 304 may comprise a mixing device 302, such as a conventional turbulent flow inducer, for mixing the first and second reactants R₁, R₂ before they enter the reaction chamber 102. The power supply may further comprise a distribution manifold 602 which as shown in FIG. 8 connects the third conduit 304 to the reaction chamber 102 through a number of injection ports 604 to thereby distribute the first and second reactants R₁, R₂ more uniformly over the CECD's 10.

Furthermore, the CECD's 10 may be arranged to facilitate the reaction of large amounts the first and second reactants R₁, R₂ within the reaction chamber 102. For example, the CECD's 10 may be grouped in layers 606 which are separated by spaces 608, and each layer may be offset relative to its adjacent layer to thereby form flow paths 610 around the ends of the layers. In this arrangement, the first and second reactants R₁, R₂ will enter the reaction chamber 102 through the injection ports 604 and flow over and around each successive layer 606 of CECD's 10. This will ensure that a large portion of the first and second reactants R₁, R₂ will react on the CECD's 10 as they progress through the reaction chamber 102.

Referring again to FIG. 7, the power supply 600 may also include a voltage regulator 518 for regulating the voltage which is produced by the CECD's 10. The voltage regulator 518 is connected to a terminal 122 to which an external device may be connected. The power supply 600 is thus capable of generating a regulated DC output which may be used to, for example, recharge a battery that is connected across the terminal 122.

Moreover, a conventional DC/AC converter 610 may be connected to the outputs of the voltage regulator 518 for converting the DC output of the CECD's into AC. The DC/AC converter 610 is connected to a terminal 612 to which an external device may be connected. The power supply 600 is thus capable of generating a regulated AC output which may be used to, for example, provide temporary power to a variety of electrical devices.

Although the various embodiments of the present invention have been described as comprising a variety of different components, it should be understood that a particular embodiment of the invention could include any appropriate combination of these components. Also, although the foregoing description does not depict separate embodiments of the invention for every possible combination and arrangement of the various components, such embodiments may be readily derived by the person of ordinary skill in the art from the above examples. Furthermore, although the various embodiments of the invention have been described in conjunction with the reaction of two reactants, it should be understood that these embodiments, and any additional embodiments that may be derived by persons of ordinary skill in the art from the above description, could be adapted to work with any number of reactants.

It should be recognized that, while the present invention has been described in relation to the preferred embodiments thereof, those skilled in the art may develop a wide variation of structural and operational details without departing from the principles of the invention. For example, the various elements shown in the different embodiments may be combined in a manner not illustrated above. Therefore, the appended claims are to be construed to cover all equivalents falling within the true scope and spirit of the invention.

1. A device for generating an electric current which comprises:
a housing;
a reaction chamber which is positioned in the housing;
a chemical energy conversion device (“CECD”) which is positioned in the housing adjacent the reaction chamber;
a first conduit which extends between the reaction chamber and a source of a first reactant;
a second conduit which extends between the reaction chamber and a source of a second reactant;
wherein when the first and second reactants are communicated through their respective conduits into the reaction chamber, they will react on the CECD and generate chemical energy which the CECD will convert into an electric current;
means connected to the CECD for transmitting the electric current to a device which is located externally of the housing.

2. The device of claim 1, further comprising means for inducing the flow of the first reactant into the reaction chamber.

3. The device of claim 2, wherein the flow inducing means comprises an air mover which is positioned in the first conduit.

4. The device of claim 2, wherein the flow inducing means comprises a venturi device which is positioned in the second conduit upstream of an intersection of the first and second conduits.

5. The device of claim 1, wherein the source of the second reactant is a container which is positioned in the housing and which comprises a supply of the second reactant.

6. The device of claim 5, further comprising means for inducing the flow of the second reactant into the reaction chamber.

7. The device of claim 6, wherein the flow inducing means comprises means for elevating the pressure in the container above the pressure in the reaction chamber.

8. The device of claim 7, wherein the pressure elevating means comprises one selected from the group consisting of a pump, a piston and an inflatable bladder.

9. The device of claim 1, further comprising a third conduit which extends between the reaction chamber and the environment and through which waste products generated by the chemical reaction are vented.

10. The device of claim 9, further comprising means for cooling the waste products.

11. The device of claim 10, wherein the cooling means comprises a heat exchanger which is thermally coupled between the third conduit and at least one of the first and second conduits.

12. The device of claim 1, further comprising means for rejecting waste heat generated by the chemical reaction from the reaction chamber.

13. The device of claim 12, wherein the reaction chamber is comprised of metal and the heat rejecting means comprises the reaction chamber.

14. The device of claim 1, further comprising means for mixing the first and second reactants upstream of the reaction chamber.

15. The device of claim 1, further comprising means for controlling the flow of the first and second reactants through their respective first and second conduits.

16. The device of claim 15, wherein the flow control means comprises a valve which is positioned in one of the first and second conduits.

17. The device of claim 15, further comprising a controller for controlling the operation of the flow control means to thereby regulate the chemical reaction to produce a desired electrical current.

18. The device of claim 17, further comprising at least one sensor for sensing a condition which is related to the chemical reaction.

19. The device of claim 18, wherein the sensor is connected to the controller and the controller controls the operation of the flow control means in response to the condition sensed by the sensor.

20. The device of claim 1, wherein the housing is configured as a battery which comprises positive and negative terminals and the electric current transmitting means comprises the positive and negative terminals.
